(19) United States
(12) Patent Application Publication
(10) Pub. No.: US 2005/0143180 A1
(43) Pub. Date: Jun. 30, 2005

(54) Boot for a constant velocity universal joint

(76) Inventor: Rory Matthew Johnson, Grand Blanc, MI (US)

Correspondence Address: Jennifer M. Brumbaugh, 3300 University Drive, Auburn Hills, MI, 48326-2362, US

(21) Appl. No.: 11/065,576

(22) Filed: Feb. 24, 2005

Related U.S. Application Data
(63) Continuation of application No. 09/303,791, filed on Apr. 30, 1999.

(51) Int. Cl. F16C 1/26

(52) U.S. Cl. 464/173

(57) ABSTRACT

A rolling diaphragm boot is adapted for coupling to a boot-can connector. The boot includes an annular member having a longitudinal axis and a crimping lip for being received by the boot-can connector. The crimping lip has a plurality of radially distributed apertures which are oriented parallel to the longitudinal axis for reducing the stiffness and increasing the compressibility of the crimping lip.

### CROSS-REFERENCE TO RELATED APPLICATIONS

This application is a Continuation of application number 09/303,791 filed on Apr. 30, 1999.

### TECHNICAL FIELD

This invention relates to a boot for a universal joint and more specifically to a rolling diaphragm boot for a constant velocity universal joint.

### BACKGROUND

Constant velocity universal joints are sometimes used in vehicles for coupling the transmission and its corresponding propeller shaft. In four-wheel drive vehicles, constant velocity universal joints are utilized to couple a transfer case to the front and rear propeller shafts extending therefrom to corresponding front and rear drive axles. A constant velocity universal joint used in these applications includes a boot that is crimped into a larger boot-can, which in turn is affixed to an outer race of the constant velocity universal joint. A rolling diaphragm boot is typically used in this application.

A rolling diaphragm boot is commonly formed of a rubber or silicone material that is soft enough that a boot of such material is compressible when crimped into the boot-can connector. However, during the operative life of a vehicle, the crimping integrity between the rolling diaphragm of the boot formed of soft material and its mating boot-can connector of a constant velocity universal joint may deteriorate. This may particularly be the case during operation in and exposure of the constant velocity universal joint to temperature extremes.

Consequently, the need has developed for an improved design for a constant velocity universal joint which includes an improved rolling diaphragm boot and a mating boot-can having an enhanced crimping integrity, and also having improved properties allowing the boot and the crimping integrity to have improved long-term durability and temperature endurance.

### SUMMARY OF THE INVENTION

The present application discloses a boot adapted for coupling to a boot-can and comprising a cylindrical neck member and an annular member. The annular member includes a longitudinal axis and a crimping lip for being received by the boot-can. The crimping lip has a plurality of radially distributed apertures. The apertures are oriented parallel to the longitudinal axis of the annular member for reducing stiffness of the boot and increasing the compressibility of the crimping lip.

### BRIEF DESCRIPTION OF THE SEVERAL VIEWS OF THE DRAWINGS

FIG. 1 is a cross-sectional side view of a constant velocity universal joint and propeller shaft assembly according to the present invention;

FIG. 2 is a perspective view of a boot and boot-can assembly according to the present invention;

FIG. 3a is a side view of the boot and boot-can assembly illustrated in FIG. 2;

FIG. 3b is a front view of the boot and boot-can assembly illustrated in FIG. 3a;

FIG. 4a is a cross-sectional side view of the boot and boot-can assembly shown in FIG. 3a, in an un-crimped state, taken along the line A-A;

FIG. 4b is an enlarged detail of the encircled portion from FIG. 4a, showing the crimping lip of the boot received within the boot can in an un-crimped state;

FIG. 5a is a cross-sectional side view of the boot and boot-can assembly shown in FIG. 3a, in a crimped state, taken along the line A-A;

FIG. 5b is an enlarged detail of the encircled portion from FIG. 5a, showing the crimping lip of the boot received within the boot can in an crimped state;

FIG. 6a is a perspective view of a first embodiment of a boot according to the present invention;

FIG. 6b is a front view of the first embodiment of the boot shown in FIG. 6a;

FIG. 6c is a cross sectional view of the first embodiment of the boot, taken along the line 6c-6c of FIG. 6b;

FIG. 7a is a perspective view of a second embodiment of a boot according to the present invention;

FIG. 7b is a front view of the second embodiment of the boot shown in FIG. 7a; and

FIG. 7c is a cross-sectional view of the second embodiment of the boot, taken along the line 7c-7c of FIG. 7b.

### DETAILED DESCRIPTION

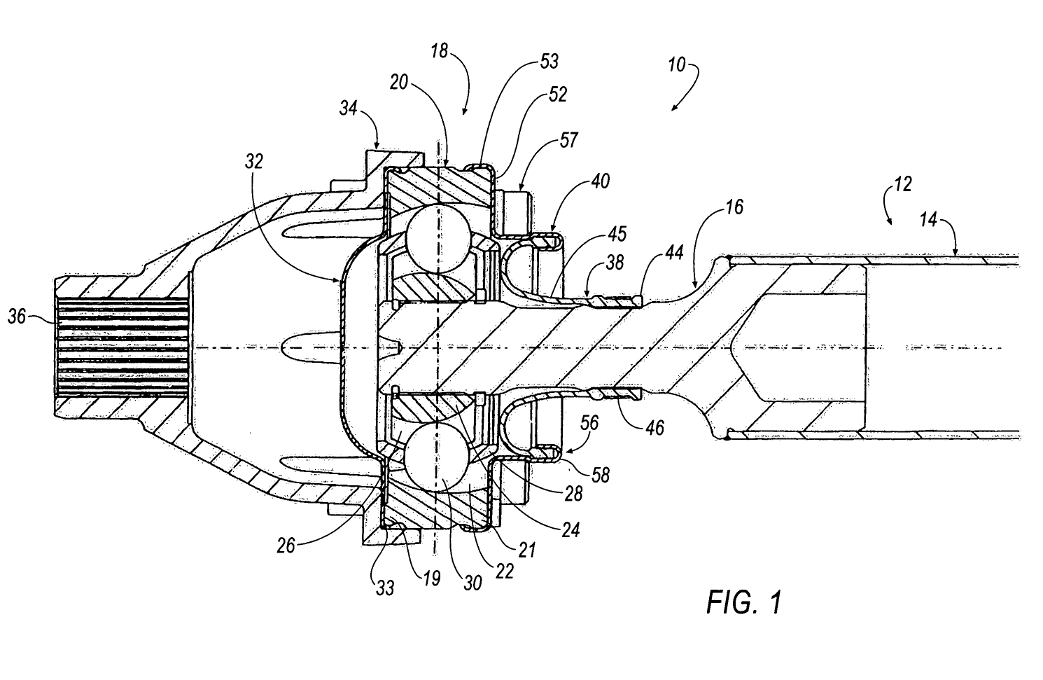

In accordance with the teachings of the present invention, FIG. 1 of the drawings shows a cross-sectional side view of a constant velocity universal joint and propeller shaft assembly 10 according to the present invention. As shown in FIG. 1, assembly 10 includes a propeller shaft 12, which in the embodiment illustrated includes a propeller shaft housing tube 14 which has a propeller stub shaft 16 aligned and coupled therewith and projecting therefrom. As is known in the art, the propeller shaft 12 is a drive shaft connecting the transmission (not shown) to the driving axle (or front and rear axles in a four-wheel drive vehicle) in order to transmit torque from the transmission to the axle.

Further included in assembly 10 is a constant velocity universal joint 18, which includes an outer race 20 having outer tracks 22, and an inner race 24 having inner tracks 26. Constant velocity universal joint 18 is of the ball-and-cage variety. Note that constant velocity joint 18 includes a cage 28 that has a plurality of windows therein, each for holding and carrying a corresponding one of a plurality of ball bearings 30. Ball bearings 30 are directed by the cage while riding on the outer and inner tracks 22 and 26, respectively, of joint 18.

Assembly 10 further includes a grease cap 32 therein. Grease cap 32 is mounted to one end of constant velocity universal joint 18 for retaining grease contained within joint 18 for keeping it lubricated and also for keeping any foreign matter and contaminants out of joint 18. As illustrated in FIG. 1, grease cap 32 has an annular flange 33, which is secured to a first end 19 of outer race 20. Grease cap 32 may also have a means for venting in order to minimize pressure fluctuations due to expansion and contraction of enclosed air space during operation of the constant velocity universal joint 38. The means for venting is generally a hole in the center dome of grease cap 32. Also illustrated is an adaptor member 34 mounted to the first end 19 of outer race 20. Adaptor member 34 includes a splined bore 36 distal the constant velocity universal joint 18. Splined bore 36 serves to couple propeller shaft 12 and constant velocity universal joint 18 to another vehicle component, such as a transmission or transfer case (not shown). The transmission or transfer case would therefore include a splined shaft that is received within the splined bore 36 of adaptor member 34, so that the transmission or transfer case may provide a power transfer to propeller shaft 12.

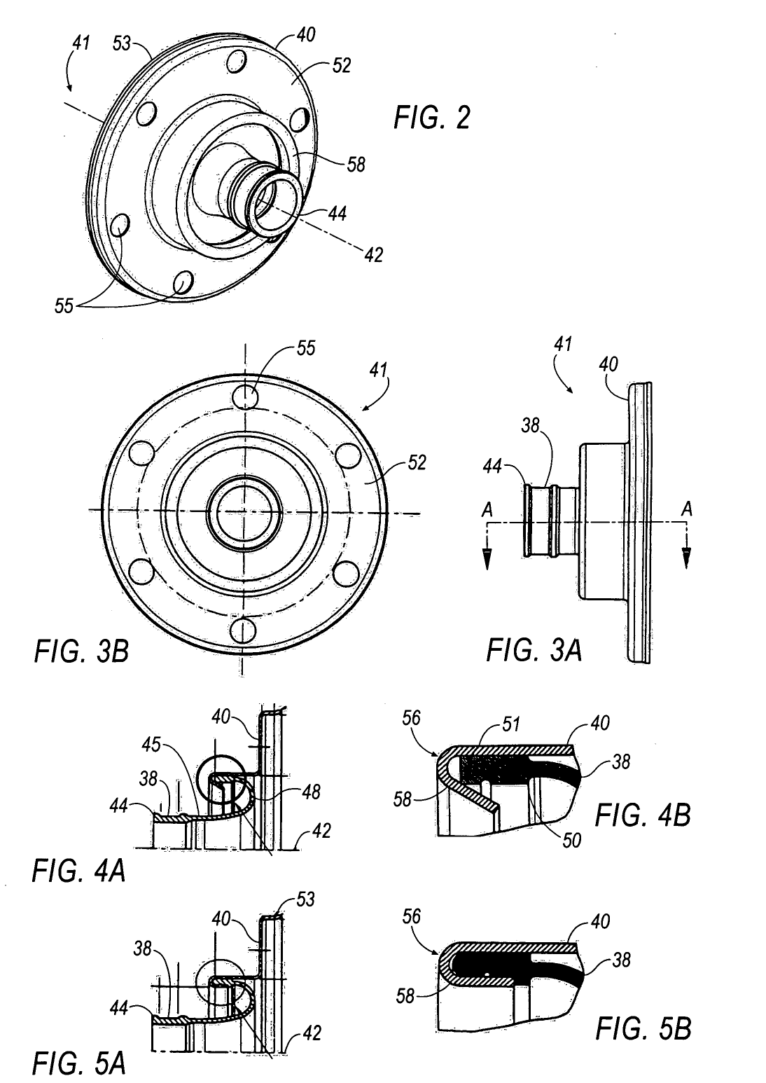

In keeping with the present invention, also included in assembly 10 is a boot 38 and a boot-can 40. As shown in the perspective view of FIG. 2 and the elevational views of FIGS. 3a-3b, 4a-4b and 5a-5b, boot 38 and boot-can 40 may form a subassembly 41. As illustrated in FIG. 4a, boot 38 is an annular member having a longitudinal axis 42. Boot 38 has a first annular neck member 44 which engages propeller shaft 12 (and more particularly propeller stub shaft 16) in order to provide a seal between constant velocity universal joint 18 and propeller shaft 12, so that (similar to grease cap 32) grease is not able to exit joint 18 and foreign matter and contaminants such as water are not able to enter joint 18 and impede its operation. With reference to FIG. 1, first annular neck member 44 of boot 38 is attached to propeller stub shaft 16 with a fastener such as an annular clamp 46 in order to maintain the seal therebetween. Such sealing and protection of constant velocity universal joint 18 is desired because, once the inner cavity of joint 18 is partially filled with grease and sealed, it is thus lubricated, and preferably lubricated for life with no required maintenance.

Boot 38 is preferably a non-convoluted rolling diaphragm boot. As shown in the cross-section of FIGS. 1, 4a and 5a, boot 38 transitions from first annular neck member 44 to a stem portion 45, then transitions from stem portion 45 through an outwardly curved (rolling diaphragm) portion 48, which then transitions to a second annular end 50, having a crimping lip 51. Second annular end 50 has a relatively larger diameter than first annular neck member 44. Stem portion 45 is substantially frusto-conical in shape and defines a longitudinal opening therethrough for receiving propeller stub shaft 16 therein. As shown in the enlarged views of FIGS. 4b and 5b, second annular end 50 includes crimping lip 51 having a greater thickness than the other wall portions of boot 38. The rolling diaphragm shape of boot 38 assists in reducing undue forces from being applied to boot 38 at high angular deflection states.

Boot-can 40 provides a means by which boot 38 may be coupled with constant velocity universal joint 18. Boot-can 40 is a connector which allows the relatively small diameter boot 38 to be mounted to the relatively large diameter outer race 20 of constant velocity universal joint 18 (or the second face 21 thereof). As shown in FIGS. 1-4b, boot-can 40 includes an outer end 52 with an annular flange 53 which is mounted to the second face 21 of outer race 20 of constant velocity universal joint 18 (or the end of outer race 20 which is disposed opposite the end 19 mated to grease cap 32). Boot-can 40 is preferably formed of a metal.

To assist in the mounting of boot-can 40 to outer race 20 universal joint 18, boot-can 40 has a plurality of holes or openings 55 distributed around its outer end 52, which correspond with bores (not shown) in outer race 20 of constant velocity universal joint 18. Accordingly, boot-can 40 may be mechanically fastened to constant velocity universal joint 18, for example, by using bolts 57 (best shown in FIG. 1) to fasten the mating components boot-can 40 and outer race 20. The other end 56 of boot-can 40 has a flange 58 that is inwardly turned toward the center of boot-can 40. In order to assemble subassembly 41, boot 38 and boot-can 40 are oriented (as shown in FIGS. 1-2, 3a-3b, 4a-4b, 5a-5b) so that the second annular portion 50 (and more particularly crimping lip 51) is received by the inwardly turned flange 58 of boot-can 40 (as shown by the “un-crimped⇄ detail of FIGS. 4a-4b). Subsequently, inwardly turned flange 58 is crimped in order to secure crimping lip 51 therein, thereby coupling boot 38 and boot-can 40 as shown by the “crimped” detail of FIGS. 5a-5b.

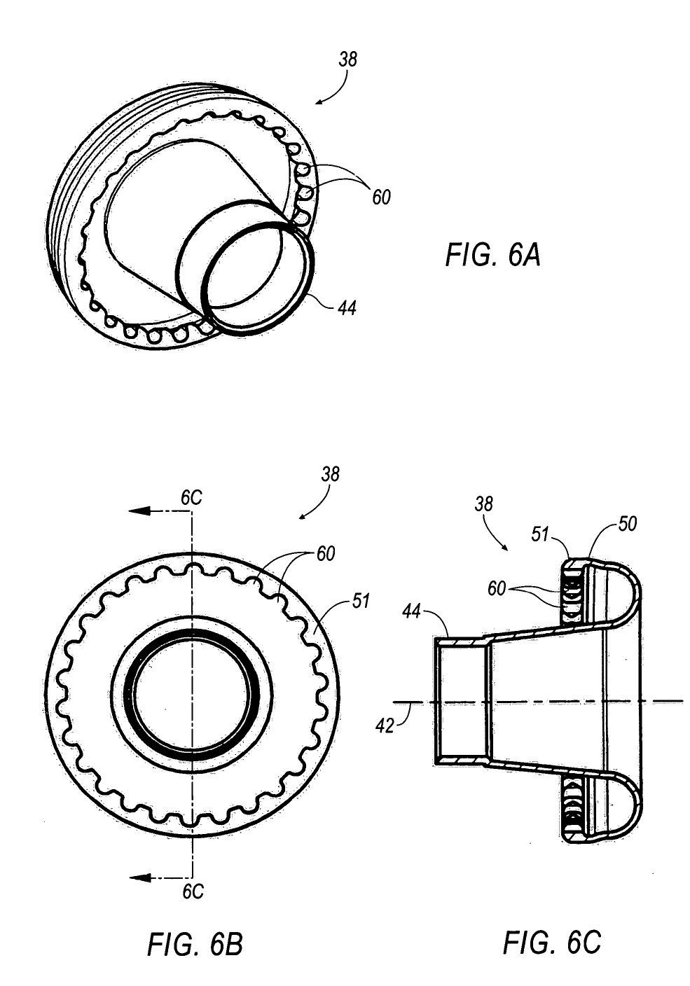

A preferred embodiment according to the present invention is illustrated in FIGS. 6a-6c. Shown therein is a boot 38 formed of a thermoplastic elastomer material. Thermoplastic properties provide for a more firm or harder boot than rubber or silicone materials typically utilized in such an application, thus providing additional stability and resistance to environmental contaminants to boot 38. As shown in the first embodiment of boot 38 shown in FIGS. 6a, 6b and 6c, a plurality of cut-outs 60 are formed in crimping lip 51. Each cut-out 60 is equally radially distributed from axis 42 along the circumference of the crimping lip 51. In a more preferred embodiment, each cut-out 60 is spaced apart in a radially distributed pattern around the circumference of crimping lip 51, as shown in FIG. 6b. Thus, boot 38 having the cut-out 60 design for crimping lip 51 has improved properties, including greater compressibility, because the material reduction in crimping lip 51 (due to cut-outs 60) reduces the effective stiffness of the thermoplastic material, thereby allowing the crimping lip 51 to have properties similar to an improved radial spring. Accordingly, the integrity of the crimp seal between crimping lip 51 (of boot 38) and flanged edge 58 (of boot-can 40) is improved, and according to the objectives of the present invention, the crimp integrity improved over the vehicle's life, and also has improved performance in cold temperature operation, where thermoplastic is better able to withstand colder temperatures. Thermoplastic material is also sufficiently rigid and substantial to withstand the loss of material in the crimping lip 51 area, due to cut-outs 60.

In the prior art, thermoplastic elastomer (TPE) materials have not been generally considered for rolling diaphragm boots because of their lower compressibility properties. However a boot made of TPE and having the rolling diaphragm form and one of the crimping lip 51 designs according to the present invention has greater compressibility properties due to the material reduction, thereby providing for reduced effective stiffness. In this manner, the integrity of the crimp seal is improved.

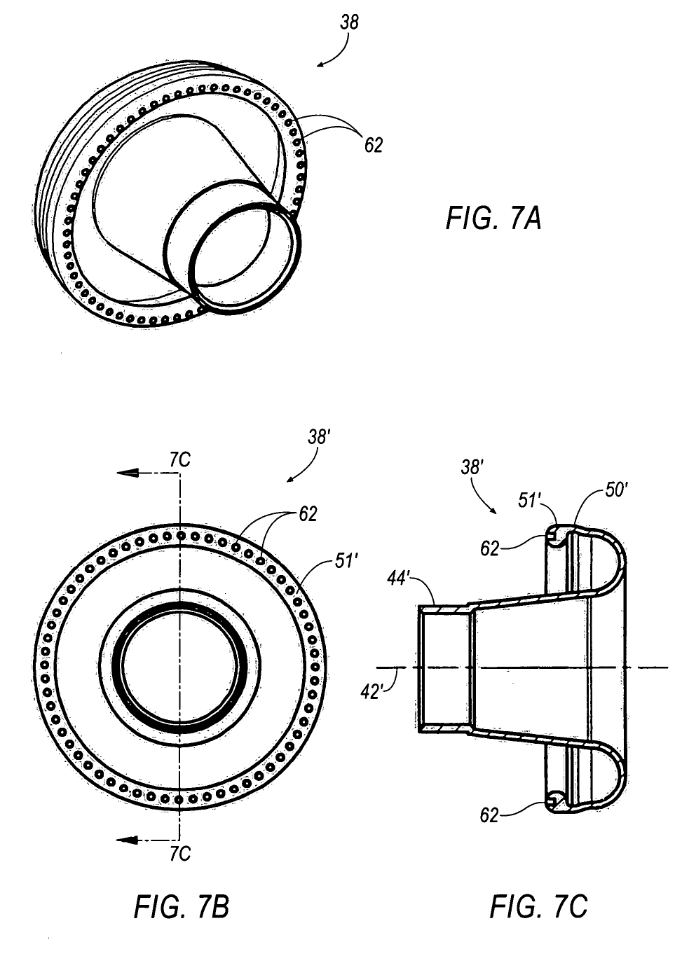

A second embodiment of a boot 38 according to the present invention is illustrated in FIG. 7, and is designated as boot 38′. Note that in the second embodiment disclosed herein, many of the similar components from previous embodiments are designated by like reference numerals carrying prime (′) designations, for consistency and ease of reference. As in the first embodiment of FIGS. 6a-6c, boot 38′ is preferably formed of a thermoplastic material. However, instead of cut-outs 60, an alternative crimping lip 51′ design is provided. As shown in FIGS. 7a, 7b and 7c, crimping lip 51′ has formed therein a plurality of relatively small apertures 62 which are formed into crimping lip 51′. Apertures 62 are particularly shown as holes in this embodiment having a diameter smaller than the thickness of crimping lip 51′, as shown in FIG. 7b. As in the previous embodiment, the apertures 62 are equally radially distributed from the longitudinal axis 42′ along the circumference of the crimping lip 51′. More preferably the apertures 62 are spaced apart in a radially distributed pattern around crimping lip 51′. As shown in the side elevational cross-sectional view of FIG. 7c (taken along line 7c-7c of FIG. 7b), each aperture extends partially into crimping lip 51′.

In one embodiment, the size of cut-outs 60 and apertures 62 are between 35% to 70% of crimping lip 51 thickness. Of course, it is contemplated that cut-outs 60 and apertures 62 may have a size and/or shape as is deemed appropriate and necessary in order to achieve the desired crimping properties according to the objects of the present invention. It is further contemplated that the cut-outs 60 and apertures 62 may be molded or otherwise formed into boots 38, 38′, respectively.

Thus the compressed crimping lip 51 thickness ratio is approximately 50% to 70% of the uncompressed crimping lip 51 thickness. The use of the cut-outs 60 or apertures 62 may reduce standard crimping force required by up to approximately 50%. In this manner, the modified geometry has reduced effective stiffness, allowing for a greater degree of compression of the boot-can 40 to boot 30. A thermoplastic elastomer rolling diaphragm boot 38, 38′ of this type further includes a better seal integrity over its operative lifetime, and particularly during cold temperature operation.

While the invention has been particularly shown and described in reference to the preferred embodiment thereof, it will be understood by those skilled in the art that various changes in form and details may be made therein without departing from the spirit and scope of the invention.

1. A boot adapted for coupling to a boot-can, the boot comprising:
a cylindrical neck member; and
an annular member having a longitudinal axis and a crimping lip for being received by the boot-can, said crimping lip having a plurality of radially distributed apertures which are oriented parallel to said longitudinal axis for reducing the stiffness and increasing the compressibility of said crimping lip.

2. The boot of claim 1, wherein the plurality of radially distributed apertures are a plurality of equally circumferentially spaced apart holes.

3. The boot of claim 1, wherein the plurality of radially distributed apertures are a plurality of equally circumferentially spaced apart radially distributed cut-outs.

4. The boot of claim 1, wherein the annular member is formed of a thermoplastic material.

5. A boot and boot-can assembly adapted for attachment to an outer race of a constant velocity universal joint, the boot and boot-can assembly comprising;
a boot-can having a first end for mating with the outer race and a second flanged end; and
a boot formed of a thermoplastic material and comprising an annular member having a longitudinal axis and a crimping lip for being received by the boot-can, the crimping lip having a plurality of radially distributed apertures which are oriented parallel to said longitudinal axis for reducing the stiffness and increasing the compressibility of said crimping lip.

6. The boot and boot-can assembly of claim 5, wherein the plurality of radially distributed apertures are a plurality of equally circumferentially spaced apart holes.

7. The boot and boot-can assembly of claim 5, wherein the plurality of radially distributed apertures are a plurality of equally circumferentially spaced apart radially distributed cut-outs.

8. A constant velocity universal joint assembly comprising:
a boot-can having a first end for mating with said outer race and a second flanged end; and
a thermoplastic rolling-diaphragm boot comprising an annular member having a longitudinal axis and a crimping lip for being received by the second end of the boot-can, the crimping lip having a plurality of radially distributed apertures which are oriented parallel to said longitudinal axis for reducing the stiffness and increasing the compressibility of said crimping lip.

9. The constant velocity universal joint assembly of claim 8, wherein the plurality of radially distributed apertures include a plurality of radially distributed holes.

10. The constant velocity universal joint assembly of claim 8, wherein the plurality of radially distributed apertures include a plurality of radially distributed cut-outs.

11. A constant velocity universal joint and propeller shaft assembly comprising:
a propeller shaft having a first end;
a constant velocity universal joint for receiving the first end of the propeller shaft and including an outer race having a first face;
a boot-can having a large-diameter end and a small-diameter flanged end, the large-diameter end for mating with the first face of the outer race; and
a thermoplastic boot having a sealing end, a tubular stem portion for receiving the propeller shaft, and an annular upturned edge crimpingly affixed to the small-diameter flanged end of the boot-can, the annular upturned edge having a plurality of radially distributed apertures for increasing the compressibility of the annular upturned edge, and the sealing end cooperating with the propeller shaft to provide a seal therewith.

12. The constant velocity universal joint and propeller shaft assembly of claim 11, wherein the plurality of radially distributed apertures include a plurality of radially distributed holes.

13. The constant velocity universal joint and propeller shaft assembly of claim 11, wherein the plurality of radially distributed apertures include a plurality of radially distributed cut-outs.
